(19) United States
(12) Patent Application Publication
(10) Pub. No.: US 2025/0385883 A1
(43) Pub. Date: Dec. 18, 2025

(54) APPLICATION MANAGEMENT

(71) Applicant: Beijing Zitiao Network Technology Co., Ltd., Beijing (CN)

(72) Inventor: Xuneng Huang, Beijing (CN)

(21) Appl. No.: 18/823,002

(22) Filed: Sep. 3, 2024

(30) Foreign Application Priority Data
Jun. 18, 2024 (CN) 202410789189.0

(51) Int. Cl. H04L 51/21; H04L 9/40; H04L 51/046

(52) U.S. Cl. CPC H04L 51/21; H04L 51/046; H04L 63/08

(57) ABSTRACT

Method for managing an application, a device and a storage medium are provided. A disclosed method includes: receiving a request for associating a target application with a target platform; and in response to the request being authenticated, associating the target application with the target platform, to cause the target application to be configured to: obtain an interaction content in the target platform; generate a response content for the interaction content; and trigger providing the response content to the target platform.

### CROSS-REFERENCE

This application claims the benefit of Chinese Patent Application No. 202410789189.0 filed on Jun. 18, 2024, entitled “METHOD AND APPARATUS FOR MANAGEMENT APPLICATION, DEVICE, AND STORAGE MEDIUM”, which is hereby incorporated by reference in its entirety.

### FIELD

Example embodiments of the present disclosure generally relate to the field of computers, and more particularly, to managing an application.

### BACKGROUND

With the development of computer technology, people may create and release various types of applications through different platforms. For example, such applications can implement message processing based on a machine learning model. However, users can usually only interact via an interface (e.g., a conversation interface) provided by the application, which greatly limits the application's usage scenarios.

### SUMMARY

In a first aspect of the present disclosure, a method for managing an application is provided. The method includes: receiving a request for associating a target application with a target platform; and in response to the request being authenticated, associating the target application with the target platform, to cause the target application to be configured to: obtain an interaction content in the target platform; generate a response content for the interaction content; and trigger providing the response content to the target platform.

In a second aspect of the present disclosure, an electronic device is provided, the device includes at least one processing unit; and at least one memory. The at least one memory is coupled to the at least one processing unit, and stores instructions for execution by the at least one processing unit. The instructions, when executed by the at least one processing unit, cause the device to perform operations that implement the method of the first aspect.

In a third aspect of the present disclosure, a computer readable storage medium is provided. The computer readable storage medium includes a computer program stored thereon, and the computer program is executable by a processor to perform operations that implement the method of the first aspect.

It should be appreciated that the content described in this section is not intended to limit critical features or essential features of embodiments of the disclosure, nor is it intended to limit the scope of the disclosure. Other features of the present disclosure will become readily appreciated from the following description.

### BRIEF DESCRIPTION OF THE DRAWINGS

The above and other features, advantages, and aspects of various embodiments of the present disclosure will become more apparent with reference to the following detailed description taken in conjunction with the accompanying drawings. In the drawings, the same or similar reference numerals denote the same or similar elements, wherein:

FIG. 1 illustrates a schematic diagram of an example environment.

FIG. 2 illustrates a flow diagram of an example process for managing an application.

FIG. 3 illustrates an example interface.

FIG. 4 illustrates a schematic structural block diagram of an example apparatus for managing an application.

FIG. 5 illustrates a block diagram of an example electronic device capable of implementing various embodiments of the present disclosure.

### DETAILED DESCRIPTION

Embodiments of the present disclosure will be described in more detail below with reference to the accompanying drawings. Although certain embodiments of the present disclosure are illustrated in the accompanying drawings, it should be understood that, the present disclosure may be implemented in various forms and should not be construed as limited to the embodiments set forth herein. On the contrary, these embodiments are provided for a more thorough and complete understanding of the present disclosure. It should be understood that, the drawings and embodiments of the present disclosure are provided for illustrative purposes only and are not intended to limit the scope of protection of the present disclosure.

It should be noted that the headings of any section/subsection provided herein are not limiting. Various embodiments are described throughout herein, and any type of embodiments can be included under any section/subsection. Furthermore, embodiments described in any section/subsection may be combined in any manner with any other embodiments described in the same section/subsection and/or different sections/subsections.

In the description of the embodiments of the present disclosure, the term “including” and the like should be understood as non-exclusive inclusion, that is, “including but not limited to”. The term “based on” should be read as “based at least in part on”. The term “one embodiment” or “the embodiment” should be read as “at least one embodiment”. The term “some embodiments” should be understood as “at least some embodiments”. Other explicit and implicit definitions may also be included below. The terms “first”, “second”, etc. may refer to different or identical objects. Other explicit and implicit definitions may also be included below.

Embodiments of the present disclosure may relate to data, acquisition and/or use of data, etc. by a user. These aspects shall follow respective legal regulations and related regulations. In embodiments of the present disclosure, all data collection, acquisition, processing, forwarding, usage, and the like, are carried out with user knowledge and confirmation. Accordingly, when implementing the embodiments of the present disclosure, the user should be informed of the types of data or information that may be involved, a usage range, a usage scenario, and the like in an appropriate manner according to relevant legal regulations, and the authorization of the user shall be obtained. The specific informing and/or authorization manner may vary according to actual situations and application scenarios, and the scope of the present disclosure is not limited in this aspect.

In the present description and the embodiments, if personal information processing is involved, the processing is performed on the basis of legitimacy (for example, the consent of subject of the personal information is obtained, or necessary for fulfillment of a contract, etc.), and will be performed only within a prescribed range or a predetermined range. The user rejecting to process personal information other than necessary information required for processing the basic function will not affect the user in using the basic function.

Conventionally, after a user completes development of a program, such as a robot program (bot), other users need to interact via the interaction interface of the bot, which greatly limits usage scenarios of the application.

Embodiments of the present disclosure provide solutions for managing an application. According to one solution, a request for associating a target application to a target platform can be received. Further, in response to the request being authenticated, the target application can be associated with the target platform, such that the target application can be configured to: obtain an interaction content in the target platform; generate a response content for the interaction content; and trigger providing the response content in the target platform.

In this way, the embodiments of the present disclosure can support associating the application with a specific platform for processing the interaction content on the platform, thereby improving the efficiency of content processing on the platform.

Various example implementations of the solution are described in further detail below with reference to the accompanying drawings.

### Example Environment

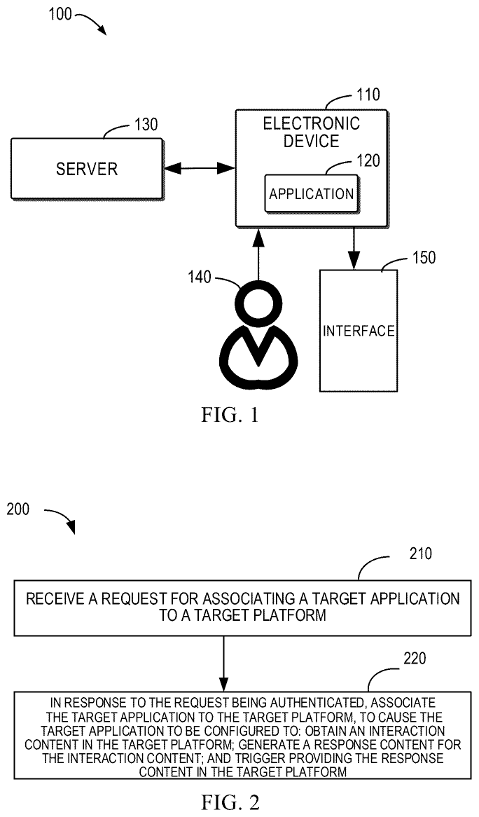

FIG. 1 illustrates a schematic diagram of an example environment 100 in which embodiments of the present disclosure can be implemented. As illustrated in FIG. 1, the example environment 100 can include an electronic device 110.

In this example environment 100, the electronic device 110 can run an application 120 that supports interface interaction. The application 120 can be any suitable type of application for interface interaction, examples of which can include, but are not limited to, a development application or other suitable application that supports application development. The user 140 may interact with the application 120 via the electronic device 110 and/or an attachment device of the electronic device 110.

In an environment 100 of FIG. 1, if the application 120 is active, the electronic device 110 may present an interface 150 for supporting application management through the application 120.

In some embodiments, the electronic device 110 communicates with a server 130 to enable the provision of services to the application 120. The electronic device 110 may be any suitable type of mobile terminal, fixed terminal, or portable terminal, including a mobile phone, a desktop computer, a laptop computer, a notebook computer, a netbook computer, a tablet computer, a media computer, a multimedia tablet, a palmtop computer, a portable game terminal, a VR/AR device, and a Personal Communication System, a PCS) device, a personal navigation device, a personal digital assistant (PDA), an audio/video player, a digital camera/camcorder, a positioning device, a television receiver, a radio broadcast receiver, an electronic book device, game device, or any combination of the foregoing, including accessories and peripherals for these devices, or any combination thereof. In some embodiments, the electronic device 110 can also support the provision of any suitable type of interface to a user (such as a “wearable” circuit or the like).

The server 130 may be an independent physical server, may also be a server cluster or a distributed system formed by a plurality of physical servers, and may also be a cloud server that provides basic cloud computing services such as cloud services, cloud databases, cloud computing, cloud functions, cloud storage, network services, cloud communications, middleware services, domain name services, security services, content distribution networks, and big data and artificial intelligence platforms. The server 130 may include, for example, a computing system/server, such as a mainframe, an edge computing node, a computing device in a cloud environment, etc. The server 130 may provide background services for the application 120 that supports a virtual scene in the electronic device 110.

A communication connection may be established between the server 130 and the electronic device 110. The communication connection may be established in a wired manner or a wireless manner. Communication connections may include, but are not limited to, Bluetooth connections, mobile network connections, Universal Serial Bus (USB) connections, Wireless Fidelity (WiFi) connections, and the like, the embodiments of the present disclosure are not limited in this regard. In embodiments of the present disclosure, the server 130 and the electronic device 110 may implement signaling interaction through a communication connection therebetween.

It should be understood that the structure and function of the various elements in environment 100 are described for exemplary purposes only, and are not intended to imply any limitation on the scope of the disclosure.

Some example embodiments of the present disclosure will be described below by continuously referring to the accompanying drawings.

### Example Process

FIG. 2 illustrates a flowchart of a process 200 for managing an application according to some embodiments of the disclosure. In the context of the present disclosure, “managing an application” may include various forms, for example, an application may be managed using the example process 200, and an existing application may also be opened and edited using an editing interface as described below. The process 200 can be implemented at the electronic device 110. The process 200 is described below with reference to FIG. 1.

As illustrated in FIG. 2, at block 210, the electronic device 110 receives a request for associating a target application with a target platform.

In some embodiments, the electronic device 110 can support the user to associate a created target application with one or more preset platforms. By way of example, the target application may include a robot program (bot) or an agent created based on a machine learning model, etc. The target application may, for example, based on configuration information of the application, automatically process the received input message, and generate the corresponding reply message.

In some embodiments, the electronic device 110 may receive the request for associating the target application with the target platform from a user (e.g., a creator or administrator of the target application). The target platform may include other applications, services, components, business modules, etc.

In some embodiments, the electronic device 110 may, for example, present a set of candidate platforms. As an example, such a set of candidate platforms are associated with the processing capability of the target application. The target application may provide, for example, the relevant capability of media content consultation, and accordingly, the set of candidate platforms may include, for example, media browsing platforms, etc.

Further, the electronic device 110 may receive a selection of the target platform from the set of candidate platforms, and accordingly obtain the request for associating the target application with the target platform. In some scenarios, associating the target application with the target platform may also be referred to as releasing the target application to the target platform.

At block 220, in response to the request being authenticated, the electronic device 110 associates the target application with the target platform, such that the target application is configured to: obtain an interaction content using the target platform; generate a response content for the interaction content; and trigger providing the response content in the target platform.

In some embodiments, upon receiving the request, the electronic device 110 may present an authentication interface associated with the target platform. The authentication interface may be configured, for example, to obtain one or more permissions from the target platform.

As an example, the electronic device 110 may provide a barcode associated with the target platform. Further, after the user logs into the target platform and scans the barcode, the user may instruct the target platform to provide one or more permissions to the target application.

Accordingly, after the target application obtains the required permission from the target platform, the target application may determine that the request for association from the user has been authenticated.

Further, after the request for association is authenticated, the target application will be associated with the target platform, and accordingly, the target application may obtain the interaction content using the target platform. In some embodiments, the interaction content may be interaction content associated with the target account. The target account may be determined based on the authentication process for the request. For example, the target account may be an account logged into by the user through scanning the barcode in an authentication interface.

In some embodiments, the interaction content obtained by the target application may include comment content from the target platform. For example, the interaction content may include comment content received for a work which is released by the target account on the target platform.

In some embodiments, the interaction content obtained by the target application may include private message content of the target platform. For example, the interaction content may include private message content sent to the target account on the target platform.

In some embodiments, the interaction content obtained by the target application may further include conversation messages of the target platform. For example, the interaction content may include single chat conversation content or group chat conversation messages sent to the target account on the target platform (e.g., an instant messaging application). For example, if the group chat conversation message includes a reference to the target account (e.g., contains the @ symbol), the group chat conversation message may be determined as being sent to the target account.

In some embodiments, the target application can process such interaction content and generate response content for the interaction content. As an example, the target application, such as a bot, may automatically generate corresponding response content based on the configuration information of the application.

Further, the target application may also trigger a provision of the response content on the target platform. By taking comment content as an example, the target application may trigger generating the reply content for the comment content on the target platform. Such reply content may be presented as coming from the permitted target account.

In this way, the embodiments of the present disclosure can support releasing applications associated with the target platform, to support automated message processing of the target platform, thereby improving the efficiency of the message processing.

In some embodiments, one or more permissions provided by the target platform to the target application may include the permission regarding allowing the target application to use one or more preset interfaces of the target platform.

For example, the target application may obtain, through the permitted preset interface, the interaction content of the target platform. Alternatively, the target application may also trigger providing the response content in the target platform through the permitted preset interface.

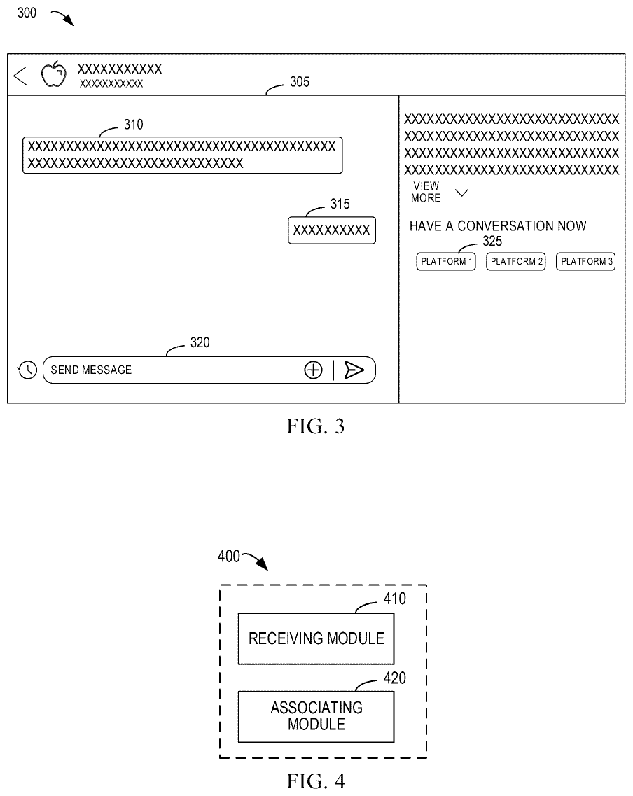

In some embodiments, as illustrated in FIG. 3, the electronic device 110 may also present a first interface 300 of the target application. The first interface 300 may present an access portal to one or more platforms associated with the target application. For example, the electronic device 110 may present an access portal 325 corresponding to “Platform 1”.

Upon receiving a selection of the access portal 325, the electronic device 110 may trigger presenting a second interface of “Platform 1”. Further, the user may interact with the target application in the second interface of “platform 1”. For example, the user may comment on a work, and accordingly may obtain the reply content generated by the target application for the comment.

In some embodiments, the first interface 300 may also include a conversation window 305 with a virtual object. The virtual object may be, for example, a virtual entity configured or created based on the target application.

In some scenarios, for example, the current login account of the target application is a first account, which may be different from the management account or the creation account of the target application. As an example, the user of the target application may register an account with the target application or the platform where the target application is located, and login the target application through the account. In some embodiments, the electronic device 110 may display, for example, in the conversation window 305, the historical interaction content 310 and corresponding historical response content 315 of the target platform 325 associated with the target application.

For example, the electronic device 110 may provide, in conversation window 305, a portal for viewing the conversation associated with the target platform. Further, the electronic device 110 may receive the selection of the portal, and display, in the conversation window 305, the conversation message associated with the target platform, i.e., a set of historical interaction messages and a set of historical response messages generated by the target application in the target platform. The set of historical interaction messages or historical response messages may include one or more historical interaction messages or one or more of historical response messages.

In some embodiments, the historical interaction message 310 may be associated with a second account of the target platform. The second account may correspond to the first account of the target application. As an example, the user of the target application may also register the corresponding account with the target platform and may login to the target platform using the second account.

For example, the user may establish a correspondence between the first account and the second account through a configuration operation, e.g., to indicate that the first account and the second account correspond to the same user. As another example, the target platform may also, for instance, allow the user to log in using the first account registered in the target application, and register the second account in the target platform for it accordingly. In this way, the second account may be associated with the first account accordingly.

Thus, the electronic device 110 may support viewing and managing, in the interface of the target application, message interactions of the target application for the associated platform.

Further, the electronic device 110 may also continuously perform the conversation associated with the target platform. Specifically, the electronic device 110 may also receive a new query message via the input control 320 in the conversation window 305, and may accordingly display the response message generated by the target application in conversation window 305.

In some embodiments, the response message may be generated by the target application based on the query message and the corresponding context information. The context information may, for example, be determined based on one or more historical interaction contents 310 and/or one or more historical response contents 315 included in the conversation associated with the target platform.

In this way, the embodiments of the present disclosure can support the user to further jump to the target application to continue dialogue interaction with the target application, thereby improving the accuracy of message processing.

In this way, embodiments of the present disclosure can support associating the application to a specific platform for processing interaction content in the platform, thereby improving the efficiency of content processing in the platform.

### Example Apparatus and Device

Embodiments of the present disclosure also provide a corresponding apparatus for implementing the methods or processes described above. FIG. 4 illustrates a schematic structural block diagram of an example apparatus 400 for managing an application in accordance with some embodiments of the present disclosure. The apparatus 400 may be implemented as or included in an electronic device 110. The various modules/components in the apparatus 400 may be implemented by hardware, software, firmware, or any combination thereof.

As illustrated in FIG. 4, the apparatus 400 includes: a receiving module 410 configured to receive a request to associate a target application with a target platform; and an association module 420 configured to associate, in response to the request being authenticated, the target application with the target platform, to cause the target application to be configured to: obtain an interaction content in the target platform; generate a response content for the interaction content; and trigger providing the response content to the target platform.

In some embodiments, the apparatus 400 further includes a presenting module, configured to: present a set of candidate platforms; and obtain the request for associating the target application with the target platform based on a selection of the target platform from the set of candidate platforms.

In some embodiments, the interaction content includes at least one of: a comment content of the target platform; a private message content of the target platform; a conversation message of the target platform.

In some embodiments, the conversation message includes a message for a target account in a group chat conversation, the target account is determined based on an authentication process for the request.

In some embodiments, the presenting module is further configured to: present, in response to receiving the request, an authentication interface associated with the target platform; and obtain, via the authentication interface, at least one permission of the target platform for the target application to authenticate the request.

In some embodiments, the target application is further configured to: obtain the interaction content of the target platform via a first interface of the target platform; or trigger providing the response content to the target platform via a second interface of the target platform.

In some embodiments, the presenting module is further configured to: present a first interface of the target application; present, in the first interface, an access portal corresponding to the target platform; and in response to a selection of the access portal, trigger presentation of a second interface of the target platform.

In some embodiments, the presenting module is further configured to: in response to the target application being associated with a first account, present, in the conversation window, a set of historical interaction content and a set of corresponding historical response content of the target platform, the set of interaction content are sent by a second account corresponding to the first account in the target platform, and the set of historical response content are generated by the target application based on the set of interaction contents.

In some embodiments, the apparatus 400 further includes an interacting module configured to: receive a query message via the conversation window; and present a response message in the conversation window, the response message is generated by the target application based on the query message and context information, the context information is associated with the set of historical interaction content and/or the set of historical response content.

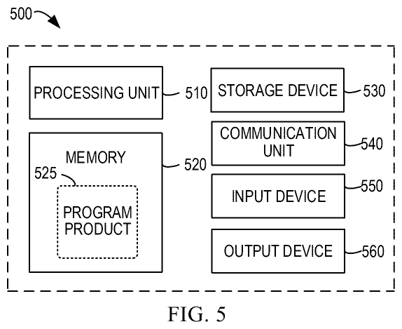

FIG. 5 illustrates a block diagram of an electronic device 500 in which one or more embodiments of the present disclosure can be implemented. It should be appreciated that the electronic device 500 illustrated in FIG. 5 is merely exemplary and should not constitute any limitation on the functionality and scope of the embodiments described herein. The electronic device 500 illustrated in FIG. 5 may be used to implement the electronic device 110 of FIG. 1.

As illustrated in FIG. 5, the electronic device 500 is in the form of a general-purpose electronic device. Components of the electronic device 500 may include, but are not limited to, one or more processors or processing units 510, a memory 520, a storage device 530, one or more communications units 540, one or more input devices 550, and one or more output devices 560. The processing unit 510 may be an actual or virtual processor and can perform various processes according to programs stored in the memory 520. In a multiprocessor system, a plurality of processing units execute computer executable instructions in parallel, so as to improve the parallel processing capability of the electronic device 500.

The electronic device 500 typically includes a plurality of computer storage media. Such media may be any available media that are accessible by electronic device 500, including, but not limited to, volatile and non-volatile media, removable and non-removable media. The memory 520 may be a volatile memory (e.g., a register, cache, random access memory (RAM)), non-volatile memory (e.g., read-only memory (ROM), electrically erasable programmable read-only memory (EEPROM), flash memory), or some combination thereof. The storage device 530 may be a removable or non-removable medium and may include a machine-readable medium such as a flash drive, a magnetic disk, or any other medium that can be used to store information and/or data and that can be accessed within the electronic device 500.

The electronic device 500 may further include additional removable/non-removable, volatile/nonvolatile storage media. Although not illustrated in FIG. 5, a magnetic disk drive for reading from or writing to a removable, nonvolatile magnetic disk such as a “floppy disk” and an optical disk drive for reading from or writing to a removable, nonvolatile optical disk may be provided. In these cases, each drive may be connected to a bus (not illustrated) by one or more data media interfaces. The memory 520 may include a computer program product 525 having one or more program modules configured to perform various methods or actions of various embodiments of the present disclosure.

The communication unit 540 implements communication with other electronic devices through a communication medium. In addition, functions of components of the electronic device 500 may be implemented by a single computing cluster or a plurality of computing machines, and these computing machines can communicate through a communication connection. Thus, the electronic device 500 may operate in a networked environment using logical connections to one or more other servers, network personal computers (PCs), or another network node.

The input device 550 may be one or more input devices such as a mouse, keyboard, trackball, etc. The output device 560 may be one or more output devices such as a display, speaker, printer, etc. The electronic device 500 may also communicate with one or more external devices (not illustrated) such as a storage device, a display device, or the like through the communication unit 540 as required, and communicate with one or more devices that enable a user to interact with the electronic device 500, or communicate with any device (e.g., a network card, a modem, or the like) that enables the electronic device 500 to communicate with one or more other electronic devices. Such communication may be performed via an input/output (I/O) interface (not illustrated).

According to an exemplary implementation of the present disclosure, a computer readable storage medium is provided, on which a computer-executable instruction is stored, wherein the computer executable instruction is executed by a processor to implement the above-described method. According to an exemplary implementation of the present disclosure, there is also provided a computer program product, which is tangibly stored on a non-transitory computer readable medium and includes computer-executable instructions that are executed by a processor to implement the method described above.

Aspects of the present disclosure are described herein with reference to flowchart and/or block diagrams of methods, apparatus, devices and computer program products implemented in accordance with the present disclosure. It will be understood that each block of the flowcharts and/or block diagrams and combinations of blocks in the flowchart and/or block diagrams can be implemented by computer readable program instructions.

These computer readable program instructions may be provided to a processing unit of a general-purpose computer, special purpose computer, or other programmable data processing apparatus to produce a machine, such that the instructions, which execute via the processing unit of the computer or other programmable data processing apparatus, create means for implementing the functions/actions specified in one or more blocks of the flowchart and/or block diagrams. These computer readable program instructions may also be stored in a computer readable storage medium that can direct a computer, a programmable data processing apparatus, and/or other devices to function in a particular manner, such that the computer readable medium storing the instructions includes an article of manufacture including instructions which implement various aspects of the functions/actions specified in one or more blocks of the flowchart and/or block diagrams.

The computer readable program instructions may be loaded onto a computer, other programmable data processing apparatus, or other devices, causing a series of operational steps to be performed on a computer, other programmable data processing apparatus, or other devices, to produce a computer implemented process such that the instructions, when being executed on the computer, other programmable data processing apparatus, or other devices, implement the functions/actions specified in one or more blocks of the flowchart and/or block diagrams.

The flowcharts and block diagrams in the drawings illustrate the architecture, functionality, and operations of possible implementations of the systems, methods and computer program products according to various implementations of the present disclosure. In this regard, each block in the flowchart or block diagram may represent a module, segment, or portion of instructions which includes one or more executable instructions for implementing the specified logical function(s). In some alternative implementations, the functions marked in the blocks may occur in a different order than those marked in the drawings. For example, two consecutive blocks may actually be executed in parallel, or they may sometimes be executed in reverse order, depending on the function involved. It should also be noted that each block in the block diagrams and/or flowcharts, as well as combinations of blocks in the block diagrams and/or flowcharts, may be implemented using a dedicated hardware-based system that performs the specified function or operations, or may be implemented using a combination of dedicated hardware and computer instructions.

Various implementations of the disclosure have been described as above, the foregoing description is exemplary, not exhaustive, and the present application is not limited to the implementations as disclosed. Many modifications and variations will be apparent to those of ordinary skill in the art without departing from the scope and spirit of the implementations as described. The selection of terms used herein is intended to best explain the principles of the implementations, the practical application, or improvements to technologies in the marketplace, or to enable those skilled in the art to understand the implementations disclosed herein.

1. A method for managing an application, comprising:
receiving a request for associating a target application with a target platform; and
in response to the request being authenticated, associating the target application with
the target platform, to cause the target application to be configured to:
obtain an interaction content of the target platform;
generate a response content for the interaction content; and
trigger providing the response content to the target platform.

2. The method of claim 1, wherein receiving the request for associating the target application with the target platform comprises:
presenting a set of candidate platforms; and
obtaining the request for associating the target application with the target platform based on a selection of the target platform from the set of candidate platforms.

3. The method of claim 1, wherein the interaction content comprises at least one of:
a comment content of the target platform;
a private message content of the target platform; or
a conversation message of the target platform.

4. The method of claim 3, wherein the conversation message comprises a message for a target account in a group chat conversation, and the target account is determined based on an authentication process of the request.

5. The method of claim 1, further comprising:
in response to receiving the request, presenting an authentication interface associated with the target platform; and
obtaining, via the authentication interface, at least one permission of the target platform for the target application to authenticate the request.

6. The method of claim 1, wherein the target application is configured to:
obtain the interaction content of the target platform via a first interface of the target platform; or
trigger providing the response content to the target platform via a second interface of the target platform.

7. The method of claim 1, further comprising:
presenting a first interface of the target application;
presenting, in the first interface, an access portal corresponding to the target platform; and
in response to a selection of the access portal, triggering presentation of a second interface of the target platform.

8. The method of claim 7, wherein the first interface comprises a conversation window with a virtual object, the virtual object corresponding to the target application, and the method further comprises:
in response to the target application being associated with a first account, presenting, in the conversation window, a set of historical interaction content and a set of corresponding historical response content of the target platform, the set of interaction content being sent by a second account corresponding to the first account in the target platform, and
the set of historical response content being generated by the target application based on the set of interaction contents.

9. The method of claim 8, further comprising:
receiving a query message via the conversation window; and
displaying a response message in the conversation window, the response message being generated by the target application based on the query message and context information, the context information being associated with the set of historical interaction contents and/or the set of historical response contents.

10. An electronic device, comprising:
at least one processing unit; and
at least one memory, the at least one memory being coupled to the at least one processing unit and storing instructions for execution by the at least one processing unit, and the instructions, when executed by the at least one processing unit, cause the electronic device to perform operations comprising:
receiving a request for associating a target application with a target platform; and
in response to the request being authenticated, associating the target application with the target platform, to cause the target application to be configured to:
obtain an interaction content in the target platform;
generate a response content for the interaction content; and
trigger providing the response content to the target platform.

11. The electronic device of claim 10, wherein receiving the request for associating the target application to the target platform comprises:
presenting a set of candidate platforms; and
obtaining the request for associating the target application with the target platform based on a selection of the target platform from the set of candidate platforms.

12. The electronic device of claim 10, wherein the interaction content comprises at least one of:
a comment content of the target platform;
a private message content of the target platform; or
a conversation message of the target platform.

13. The electronic device of claim 12, wherein the conversation message comprises a message for a target account in a group chat conversation, and the target account is determined based on an authentication process of the request.

14. The electronic device of claim 10, the acts further comprising:
in response to receiving the request, presenting an authentication interface associated with the target platform; and
obtaining, via the authentication interface, at least one permission of the target platform for the target application to authenticate the request.

15. The electronic device of claim 10, wherein the target application is configured to:
obtain the interaction content of the target platform via a first interface of the target platform; or
trigger providing the response content for the target platform via a second interface of the target platform.

16. The electronic device of claim 10, the acts further comprising:
presenting a first interface of the target application;
presenting, in the first interface, an access portal corresponding to the target platform; and
in response to a selection of the access portal, triggering presentation of a second interface of the target platform.

17. The electronic device of claim 16, wherein the first interface comprises a conversation window with a virtual object, the virtual object corresponding to the target application, and the acts further comprises:
in response to the target application being associated with a first account, presenting, in the conversation window, a set of historical interaction content and a set of corresponding historical response content of the target platform, the set of interaction content being sent by a second account corresponding to the first account in the target platform, and
the set of historical response content being generated by the target application based on the set of interaction contents.

18. The electronic device of claim 17, the acts further comprising:
receiving a query message via the conversation window; and
displaying a response message in the conversation window, the response message being generated by the target application based on the query message and context information, the context information being associated with the set of historical interaction contents and/or the set of historical response contents.

19. A non-transitory computer readable storage medium comprising a computer program stored thereon, wherein the computer program is executable by a processor to cause the processor to perform operations comprising:
receiving a request for associating a target application with a target platform; and
in response to the request being authenticated, associating the target application with the target platform, to cause the target application to be configured to:
obtain an interaction content of the target platform;
generate a response content for the interaction content; and
trigger providing the response content to the target platform.

20. The non-transitory computer readable storage medium of claim 19, wherein receiving the request for associating the target application to the target platform comprises:
presenting a set of candidate platforms; and
obtaining the request for associating the target application with the target platform based on a selection of the target platform from the set of candidate platforms.
